(19) United States
(12) Patent Application Publication
(10) Pub. No.: US 2009/0164334 A1
(43) Pub. Date: Jun. 25, 2009

(54) System and method for recommending personalized gift

(75) Inventors: Anthony A. Schmidt, Lawrence, KS (US); Shannon Griswold, Shawnee, KS (US); Kelly A. Danaher, Lawrence, KS (US)

Correspondence Address: Stephen R. Robinson, 5005 McCall St., Rockville, MD, 20853, US

(73) Assignee: Heart of America E-Commerce, L.L.C

(21) Appl. No.: 12/004,858

(22) Filed: Dec. 21, 2007

(51) Int. Cl. G06Q 30/00

(52) U.S. Cl. 705/26

(57) ABSTRACT

A method and online system for recommending gifts to a user, for a gift recipient, includes determining social relational aspects between the giver and gift recipient, determining personality traits of the giver or the recipient and calculating and then displaying to the user one or more recommended gifts for purchase. Personality, occupation and style traits are numerically rated in conjunction with product attributes of a population of potential gifts for accurate calculation of optimized gift recommendations. Gifts are rated by an online community associated with the system. The system may also learn by a feedback loop for successful and unsuccessful predictions of gift desirability, thus resulting in greater gift recommendation accuracy over time.

### BACKGROUND OF THE INVENTION

1. Field of the Invention

The present invention relates to a method and system utilizing a web-based, interactive environment. More particularly, it is directed to an online environment using personalized information for recommending a set of gifts likely to be very desirable by the intended recipient.

2. Description of Related Art

Gift selection has been seen as a daunting task probably since the origin of the practice in prehistory. Because of the essentially personal nature of the activity, many gift givers are intimidated by the very real chance of selecting a gift not pleasing to the recipient. Even for those who are able to discern how the gift will be perceived by the recipient, the task may still be seen as very time consuming or stressful.

With the advent of online purchasing of goods, some convenience has been added to the process, yet the inherent stress remains for those givers who care about how the gift will be perceived. Some attempts have been made to recommend gifts, but have been largely directed to “collaborative filtering,” that is to say, making generalized gift recommendations based on collecting taste information from many users and/or prior purchasing patterns.

These attempts however have the shortcoming of not truly “personalizing” the gift selection, not being based on aspects such as the passions, hobbies and occupation of the recipient, and not reflecting the nature of the relationship between the giver and recipient.

### SUMMARY OF THE INVENTION

The present invention solves the problems of the prior art by providing a convenient, web-based environment for an online user to identify relationship aspects between giver and recipient, as well as taking into account the passions, style and occupation of the recipient in order to provide a set of personalized gift options and to do so in a matter of minutes.

The invention provides a system and method for recommending one or more gifts to a user for a gift recipient by determining social relational aspects between a giver and the recipient. The user also provides personality traits of the giver and/or recipient and then the system calculates and displays to the user one or more recommended gifts for purchase.

In various embodiments, the set of all possible recommended gifts is continually expanded by fostering a community of system users who recommend new gift products. The system provides a method for the user to propose a new gift product and also provides numerical criteria for establishing when such gift product has reached a mathematical threshold of approval. The system then provides a method for each approved gift to be coded by a select team of human coders. Each approved new gift product is then coded for certain gift recommending criteria. The coding is moderated, preferably by a human with administrative privileges in the system. Those new gift products receiving a sufficient coding evaluation are then entered into the total population of potentially recommended gifts.

The system learns to become a better predictor by respectively incrementing and decrementing coefficients used in calculating recommending gifts, based on a feedback loop of accuracy.

### BRIEF DESCRIPTION OF THE DRAWINGS

FIG. 1 illustrates an inventive system in block diagram form for use by a plurality of users and an administrative group;

FIG. 2 is a block diagram of the system of FIG. 1 in more detail;

FIG. 3 is a screen display of The Gift Professor homepage, as generated by the system of FIG. 1;

FIG. 4 is a secondary display screen with reference to the homepage of FIG. 3;

FIG. 5 is a secondary display screen with reference to the homepage of FIG. 3;

FIG. 6 is a secondary display screen with reference to the homepage of FIG. 3;

FIG. 7 is a secondary display screen with reference to the homepage of FIG. 3;

FIG. 8 is a secondary display screen with reference to the homepage of FIG. 3;

FIG. 9 is a secondary display screen with reference to the homepage of FIG. 3;

FIG. 10 is a secondary display screen with reference to the homepage of FIG. 3;

FIG. 11 is a secondary display screen with reference to the homepage of FIG. 3;

FIG. 12 is a screen display of a Gift Givers Say So homepage, as generated by the system of FIG. 1;

FIG. 13 is a secondary display screen with reference to the homepage of FIG. 12;

FIG. 14 is a secondary display screen with reference to the homepage of FIG. 12;

FIG. 15 is a secondary display screen with reference to the homepage of FIG. 12;

FIG. 16 is a secondary display screen with reference to the homepage of FIG. 12;

FIG. 17 is a secondary display screen with reference to the homepage of FIG. 12;

FIG. 18 is a secondary display screen with reference to the homepage of FIG. 12;

FIG. 19 is a secondary display screen with reference to the homepage of FIG. 12;

FIG. 20 is a secondary display screen with reference to the homepage of FIG. 12;

FIG. 21 is a process chart for recommending new gift products;

FIG. 22 is a secondary display screen with reference to the homepage of FIG. 12;

FIG. 23 is a secondary display screen with reference to the homepage of FIG. 12;

FIG. 24 is a box diagram for calculation of POPS predictor values; and

FIG. 25 is a box diagram for calculation of Relationship Aspect predictor values.

### DETAILED DESCRIPTION

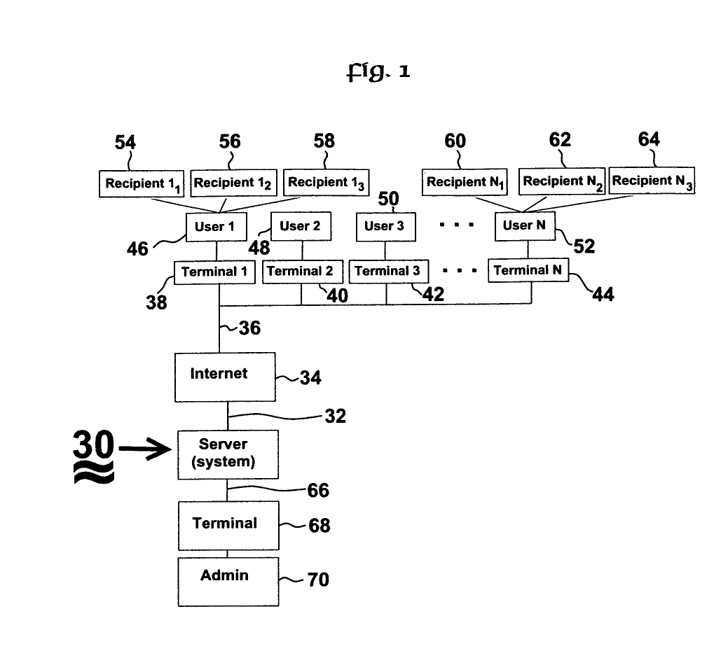

Referring to the drawings in general and FIG. 1 in particular, a system or server 30 is illustrated in box diagram form. System 30 is accessible via a connecting link 32 to the Internet 34. Additional connecting links 36 provide Internet connections to a set of end terminals, as denoted by reference numerals 38-44.

A set of human users denoted by reference numerals 46-52, may access system 30 via terminals 38-44 for use in accordance with the invention. User 46 has three representative gift recipients associated with his use of system 30, namely reference numerals 54-58. Likewise, user 52 has three representative gift recipients associated as designated by reference numerals 60-64.

Another connecting link 66 provides connection to a terminal 68 for use by a human administrator 70. It should be noted that connecting link 66 could be an Internet connection such as 32 or a local area network, or the like. System 30 allows users 46-52 to simultaneously, or at various times purchase gifts online for one or more of recipients such as 54-64, as well as utilizing other services detailed below.

Users 46-52 are illustrative in nature. In normal use, system 30 may accommodate a much larger number of simultaneous users. It should also be noted that user 46 will typically, though not necessarily be the gift giver. User 46 could also be a surrogate for a gift giver, such as a spouse. Finally, it should be noted that user 46 could be selecting a gift for himself, with similar effectiveness.

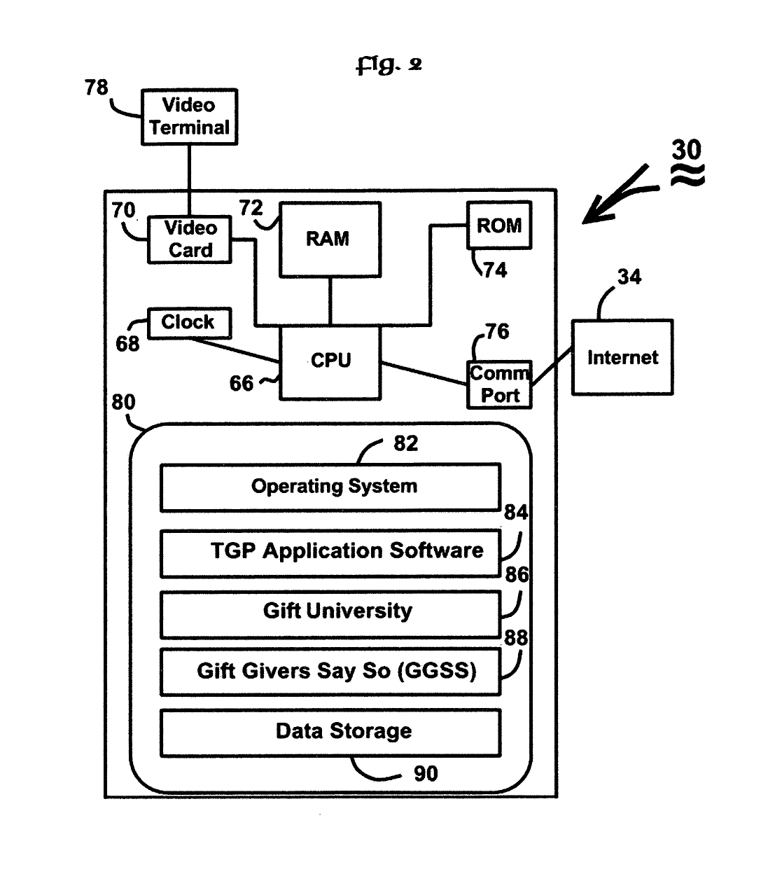

Referring to FIG. 2, system 30 (which may itself be a server or be hosted on a server's facilities) is shown in more detail. System 30 includes a CPU 66, a clock 68, a video card 70, a RAM element 72, a ROM element 74, a communications port 76 and, optionally, a video terminal 78. System 30 also includes a software storage area 80 for non-volatile storage. Included in software storage 80 is a software operating system 82, The Gift Professor (TGP) software 84, Gift University (GU) software 86, Gift Givers Say So (GGSS) software 88 and data storage 90.

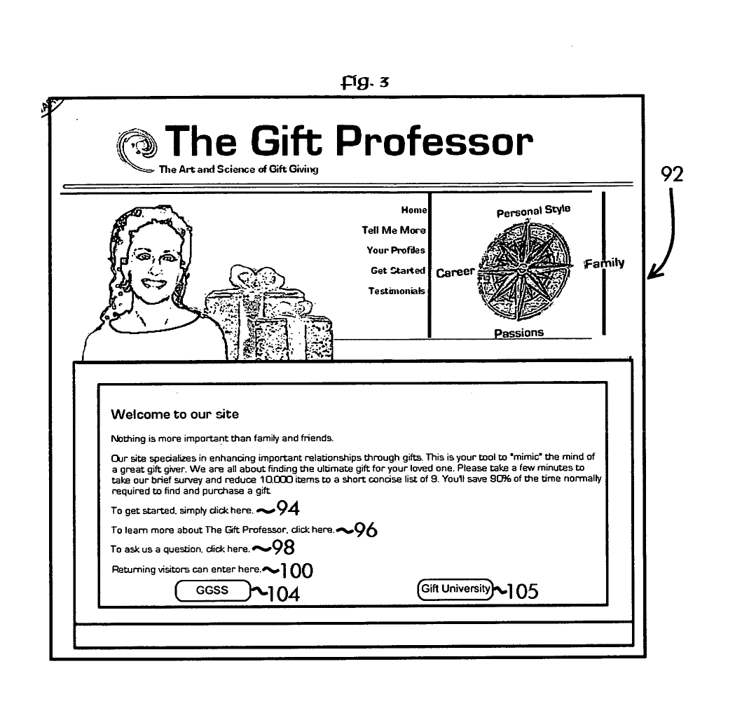

TGP software 84, GU software 86 and GGSS software 88 include elements for generating screen displays to be described in succeeding paragraphs. TGP software 84, is capable, upon appropriate prompting, of generating a homepage as indicated by reference numeral 92 as shown at FIG. 3. TPG homepage 92 includes a “Get Started” link 94, a “Learn More About” link 96, a “Question” link 98, a “Returning Visitors” link 100, a “Your Profile” link 102, a “GGSS” link 104 and a “GU” link 105.

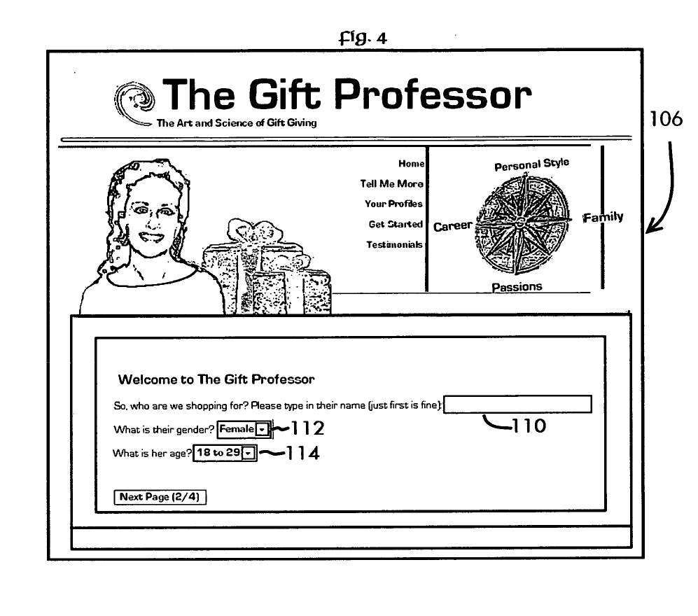

Referring to FIG. 4, a display screen 106 is shown Display screen 106 is obtained by selecting the “Get Started” link 94 on display screen 92 of FIG. 3. Display screen 106 provides for interactive data input points at reference numerals 110, 112 and 114 as indicated.

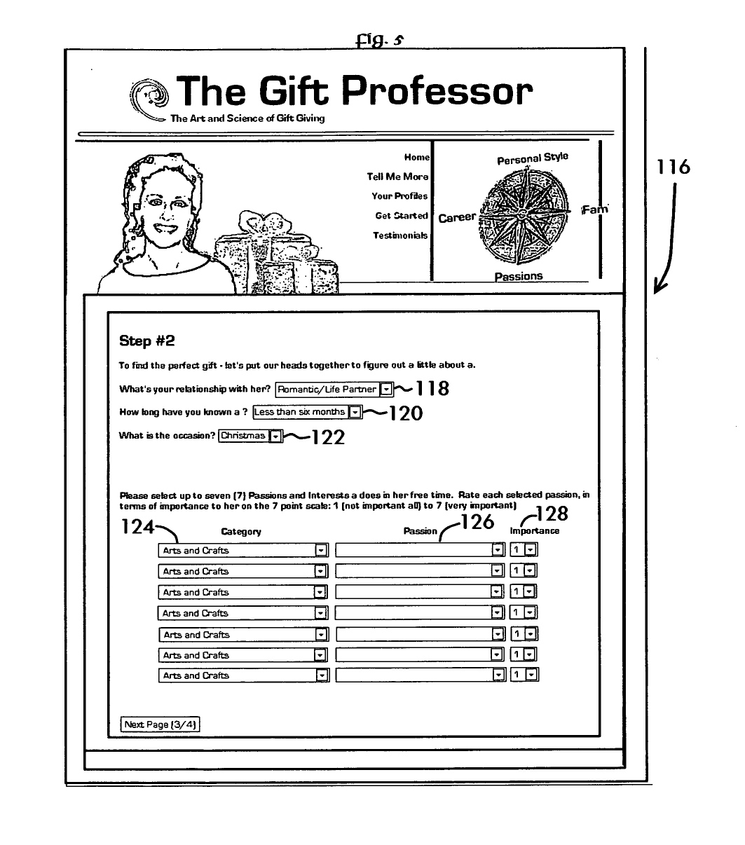

FIG. 5 provides a “Get Started” second page display screen 116 which is sequential to “Get Started” display screen of 106 (FIG. 4). Display screen 116 provides interactive data input points 118-128 as indicated.

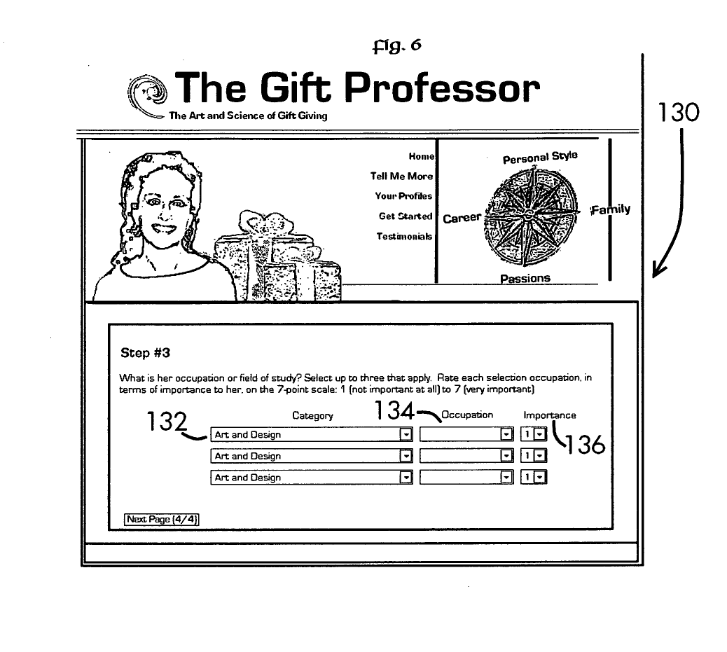

FIG. 6 provides a “Get Started” third page display screen 130 which is sequential to display screen 116 of FIG. 5. Display screen 130 provides interactive data input points 132-136.

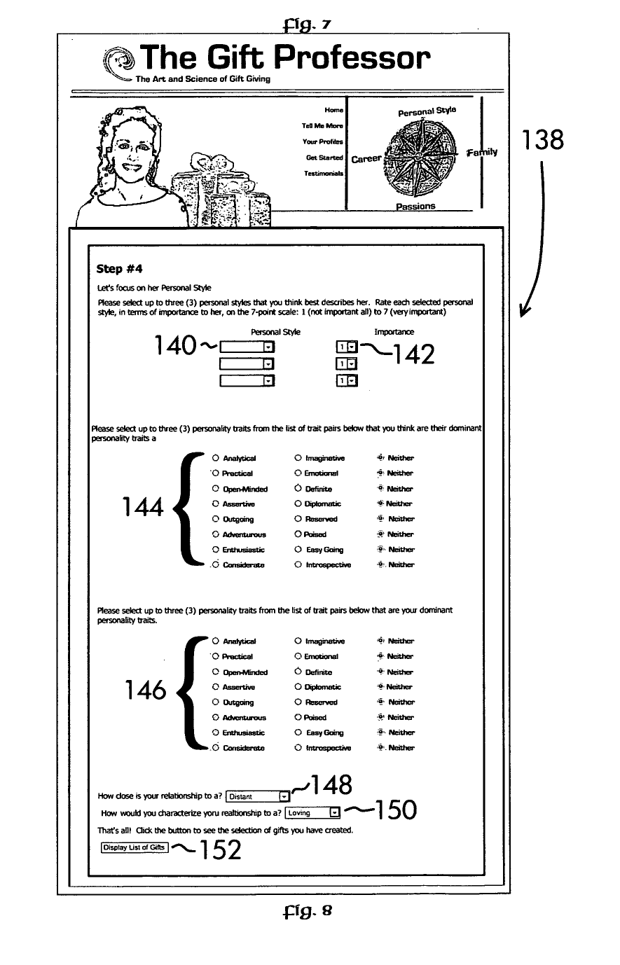

FIG. 7 provides a “Get Started” fourth page display screen 138 which is sequential to display screen 130 of FIG. 6. Display screen 138 provides interactive data input points 140-152.

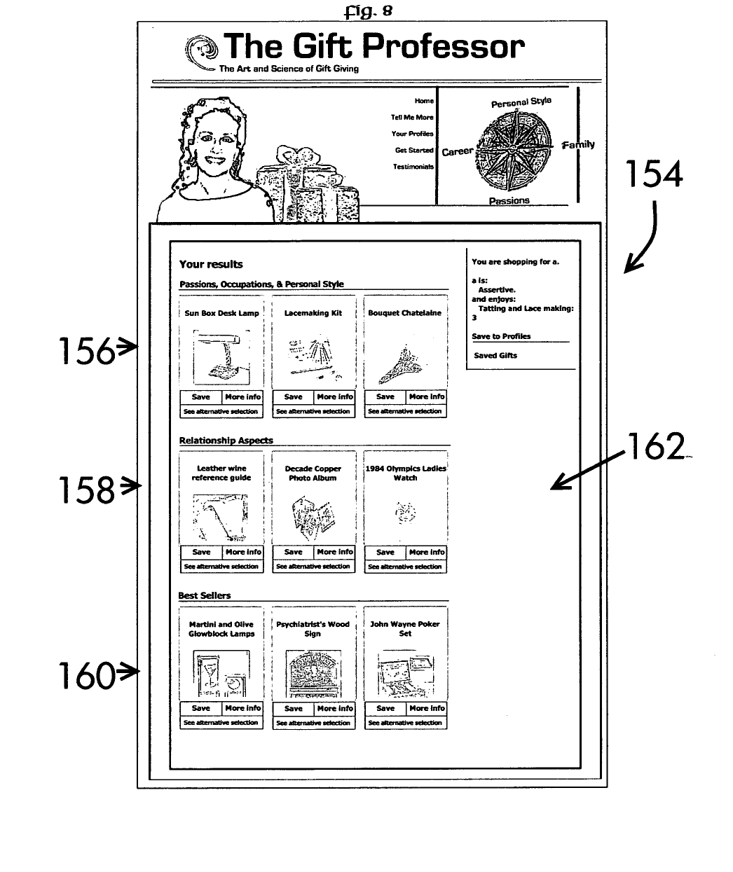

FIG. 8 illustrates a “Get Started” a fifth page display screen 154 which is sequential to display screen 138 of FIG. 7. Display screen 154 includes three sets of recommended gifts respectively 156, 158 and 160, referred to as “The Nines Page.” Additionally, display screen 154 provides a space for a user's synopsized recipient profile 161 and a space for “Saved Gifts” 162.

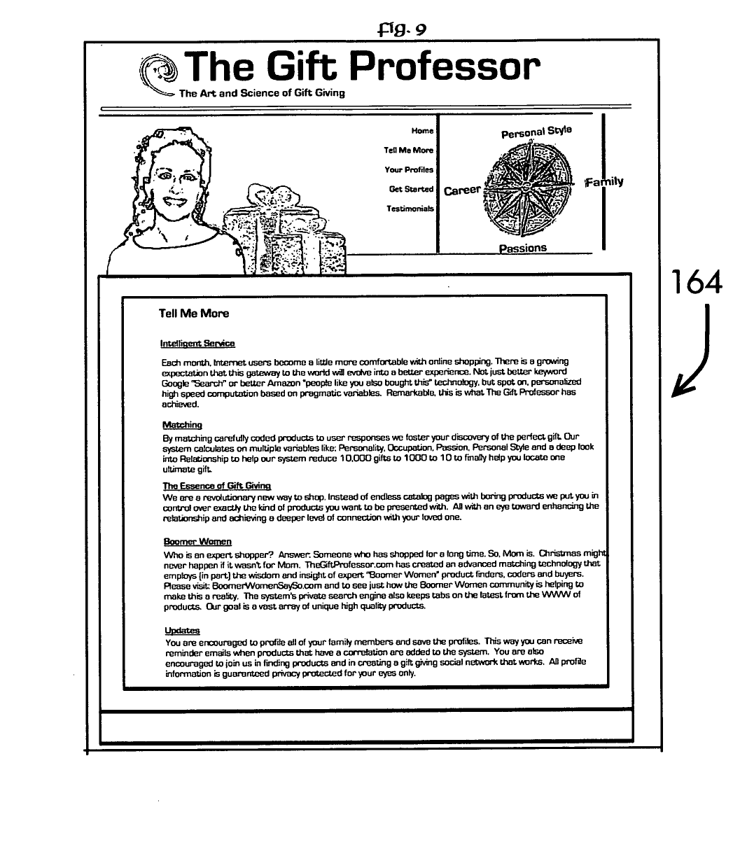

FIG. 9 is a “Tell Me More” display screen 164 generated by “Tell Me More” link 96 of FIG. 3.

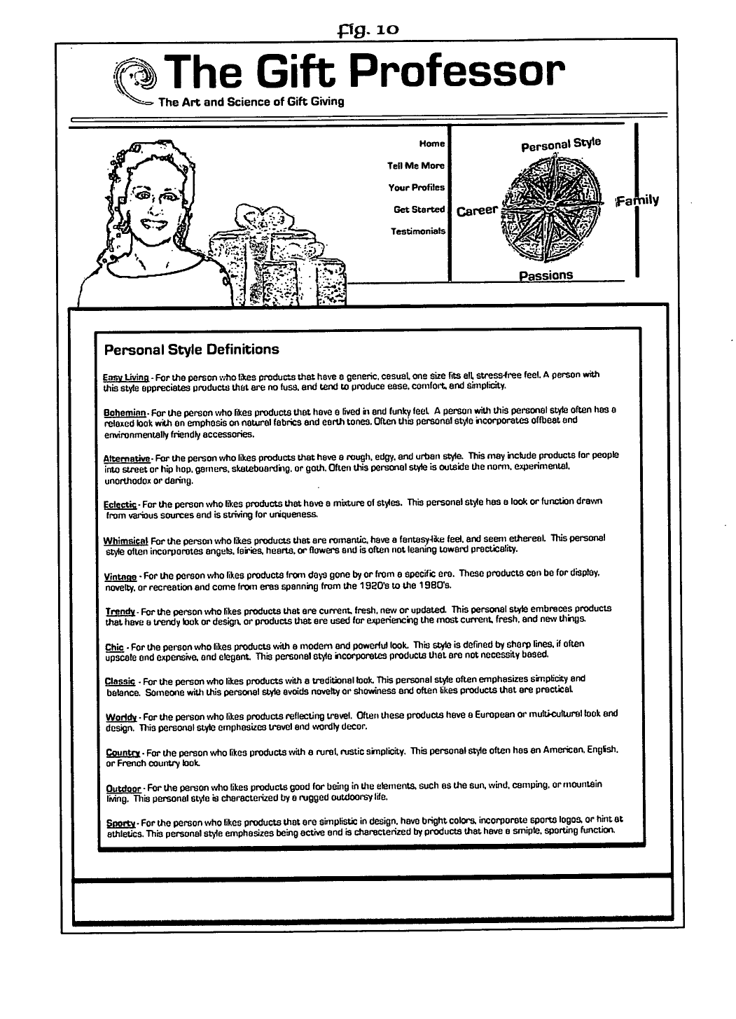

FIG. 10 is a “Personal Style” definitions display screen as indicated by 166.

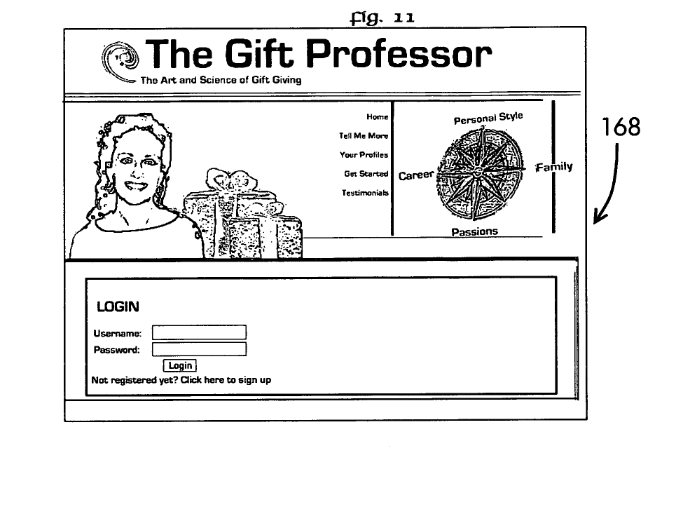

FIG. 11 is a “Log In” display screen 168 obtained by selecting the “Returning Visitors” link 100 of FIG. 3.

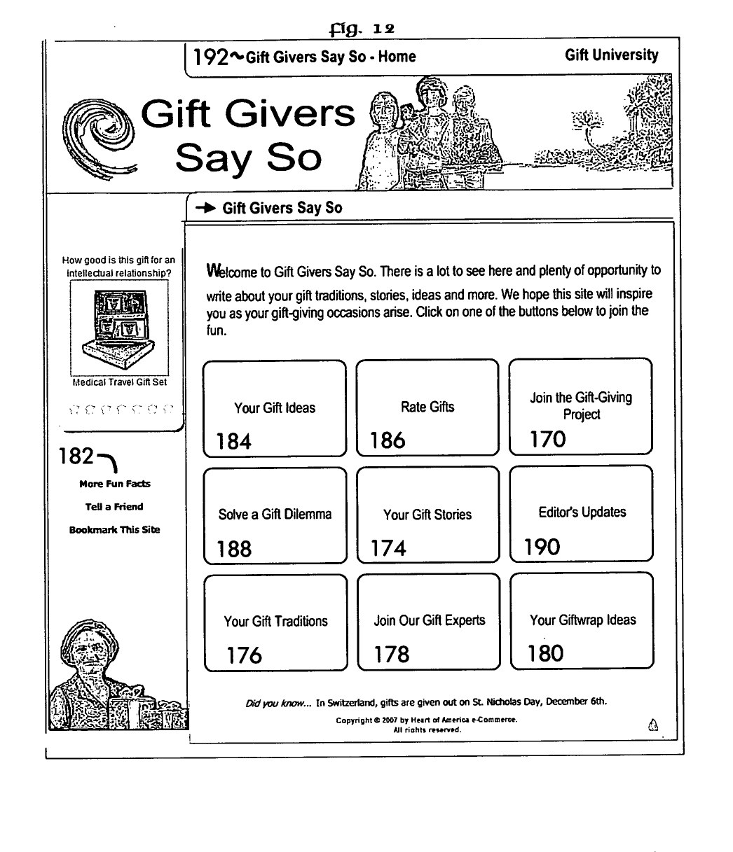

FIG. 12 is a “Gift Givers Say So” homepage display screen 170 which is obtained by selection of “GGSS” button 104 of FIG. 3. FIG. 12 includes links for various other pages as indicted at reference numerals 172-188. In addition, “GGSS” homepage 170 includes a blog area 190 and a “TGP” button 192.

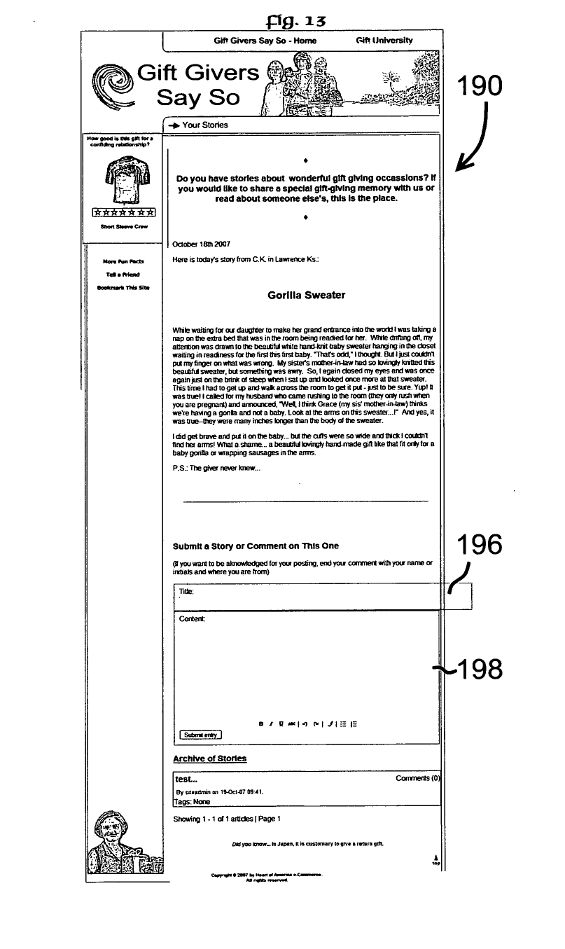

FIG. 13 is a GGSS “Stories” display screen 194 obtained by selection of link 190 as shown in FIG. 12. FIG. 13 includes interactive data input points 196 and 198 as indicated.

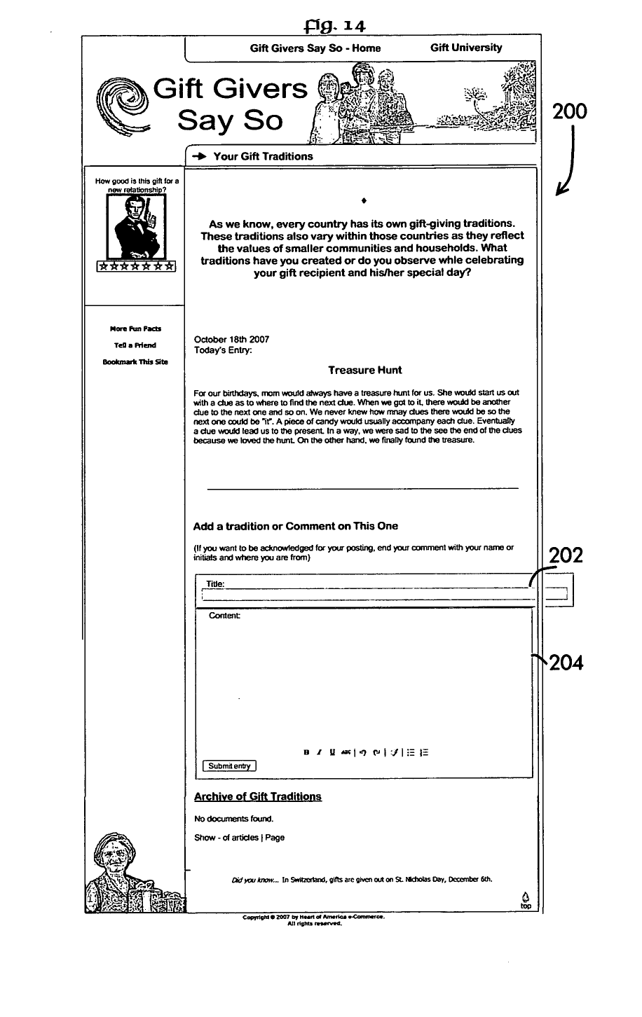

FIG. 14 is a GGSS “Traditions” display screen 200 obtained by selection of link 176 of FIG. 12. FIG. 14 includes interactive data input points 202 and 204 as indicated.

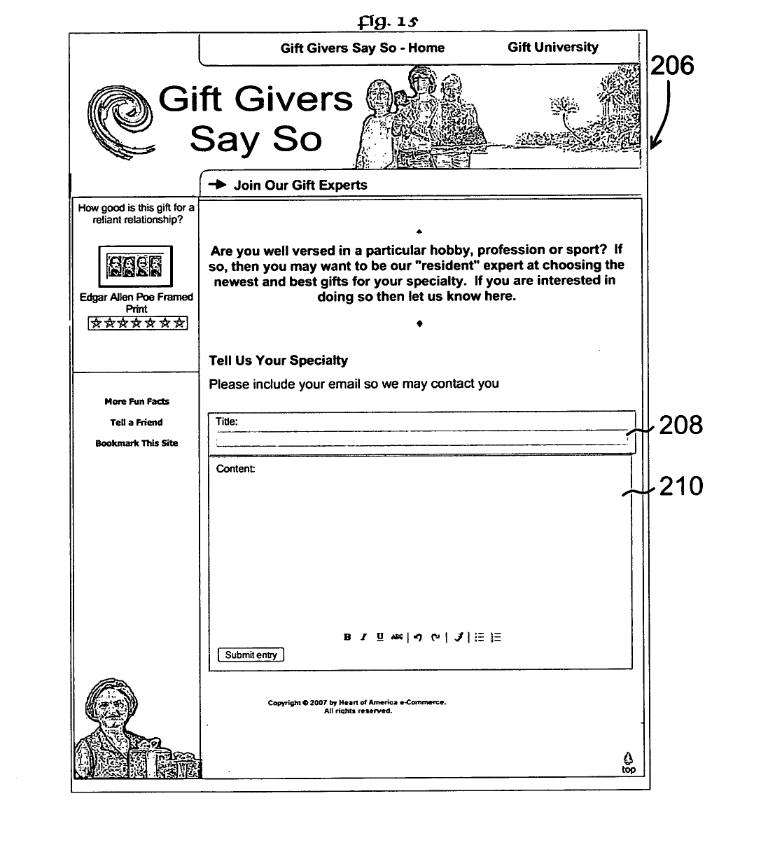

FIG. 15 is a GGSS “Join Our Gift Experts” display screen 206 obtained by selection of link 178 of FIG. 12. FIG. 14 includes interactive data input points 208 and 210 as indicated.

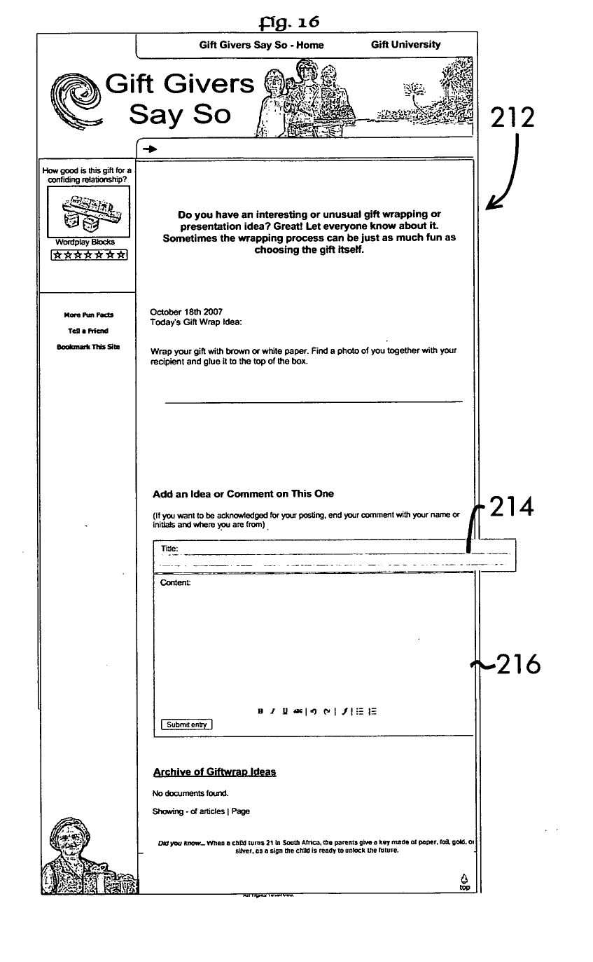

FIG. 16 is a GGSS “Your Gift Wrap Ideas” display screen 212 obtained by selection of link 180 of FIG. 12. FIG. 16 includes interactive data input points 214 and 216 as indicated.

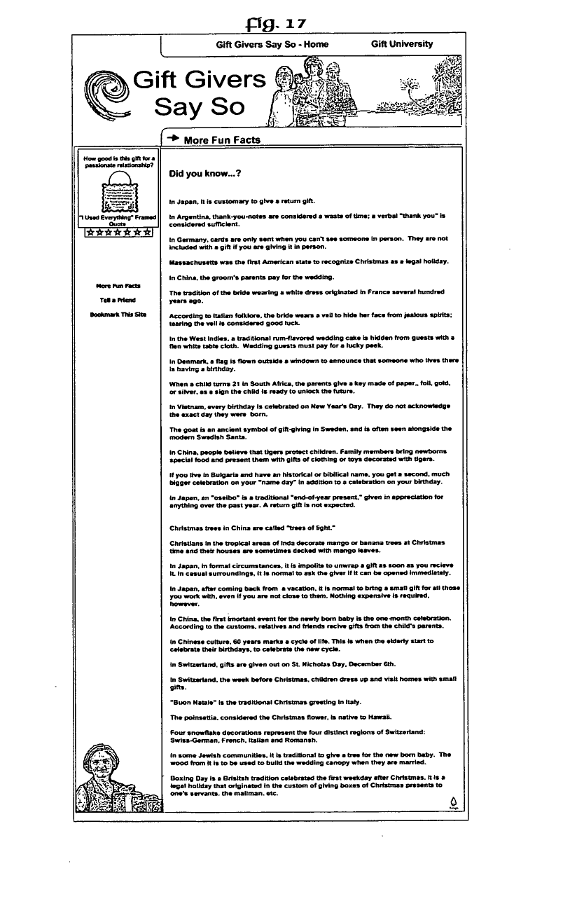

FIG. 17 is a GGSS “More Fun Facts” display screen 218 obtained by selection of link 182 of FIG. 12.

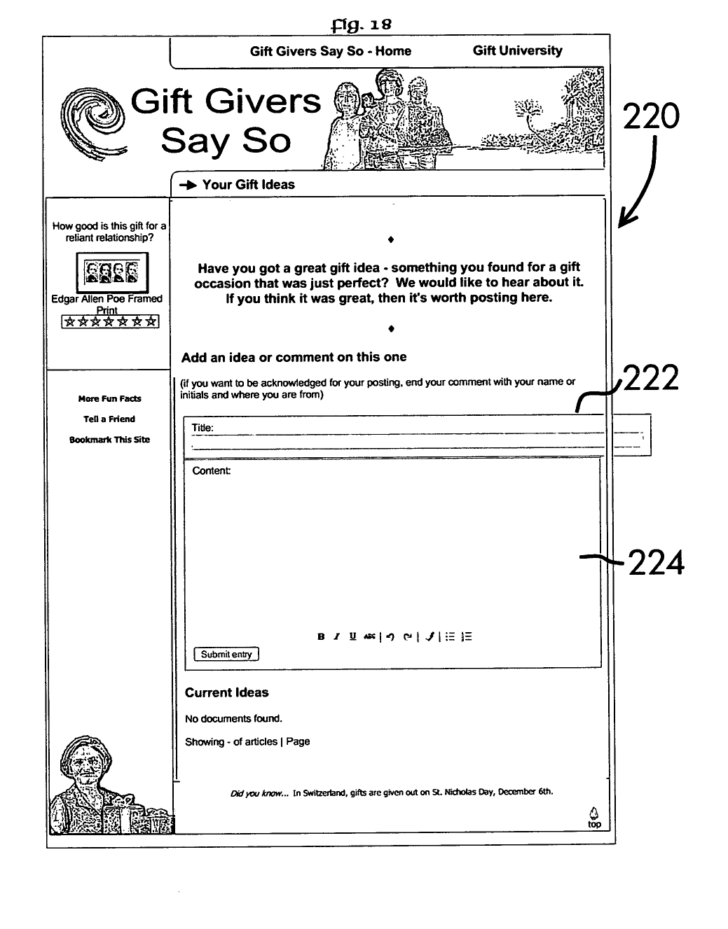

FIG. 18 is a GGSS “Your Gift Ideas” display screen 220 obtained by selection of link 184 of FIG. 12. FIG. 18 includes interactive data input points 222 and 224 as indicated.

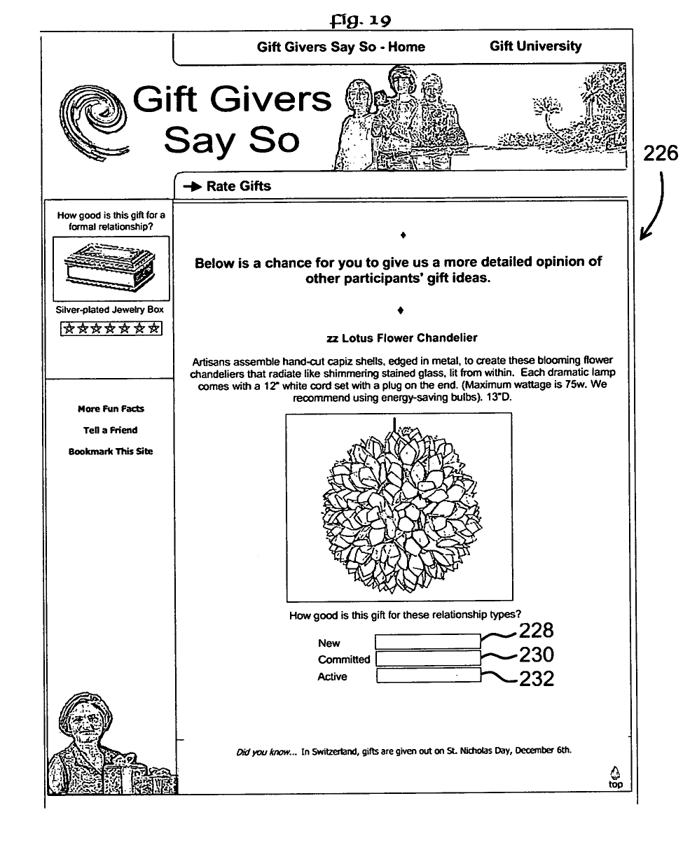

FIG. 19 is a GGSS “Rate Gifts” display screen 226 obtained by selection of link 186 of FIG. 12. FIG. 19 includes interactive data input points 228, 230 and 232 as indicated.

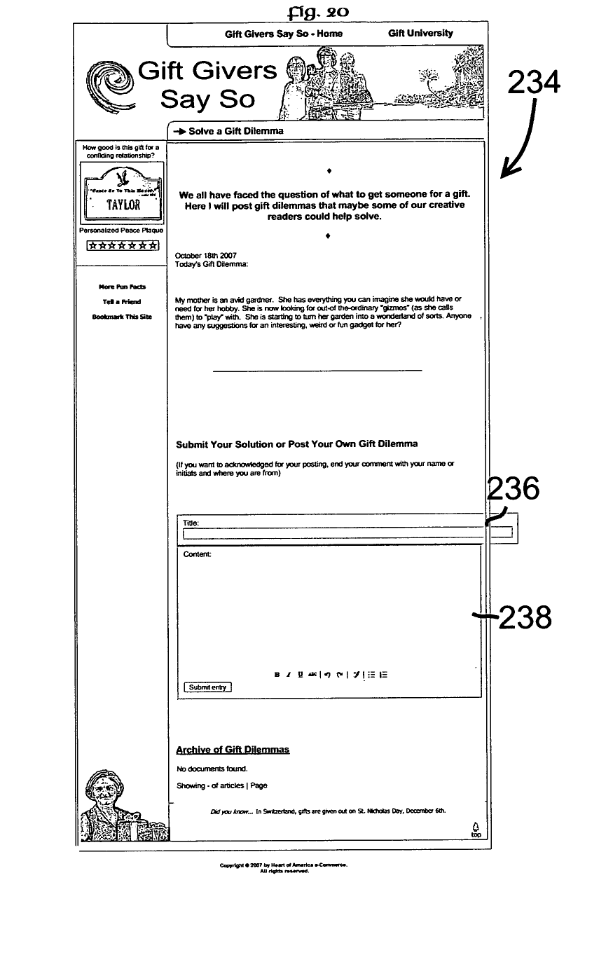

FIG. 20 is a GGSS “Solve A Gift Dilemma” display screen 234 obtained by selection of link 188 of FIG. 12. FIG. 20 includes interactive data input points 236 and 238 as indicated.

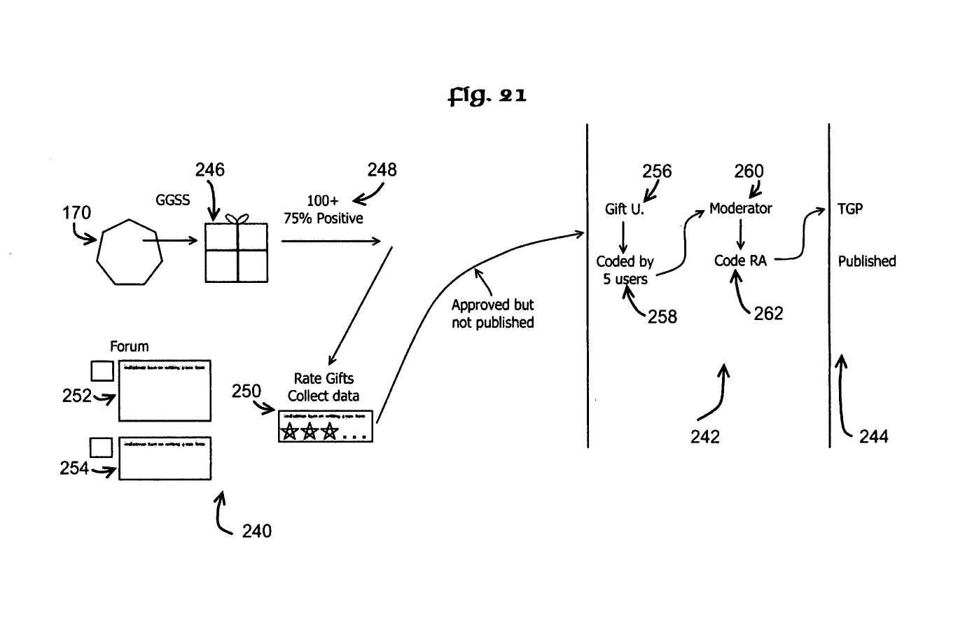

FIG. 21 illustrates a process of user-proposed gift products for addition to the total population of gift products available for recommendation. FIG. 21 illustrates a three stage inventive approach to selecting gift products for a gift product population, as well as a method of selecting one or more gifts from the gift product population. In particular, FIG. 21 illustrates three stages (separated by lines for clarity), namely a Gift Giver Say So (GGSS) stage 240, a Gift University (GU) stage 242 and The Gift Professor (TGP) stage 244, respectively associated with GGSS software 88, GU software 86 and TGP software 84.

GGSS stage 240 includes GGSS homepage 170, a GGSS proposed gift product substage 246, a Thumbs Up/Down substage 248, a Rate Gifts substage 250, a Propose Gift Product Forum 252 and a Solve A Gifts Dilemma Forum 254.

GU stage 242 includes a GU substage 256, a coding substage 258, a moderator 260 and a coding Relationship Aspect substage 262. Moderator 260 may be human or an automated function.

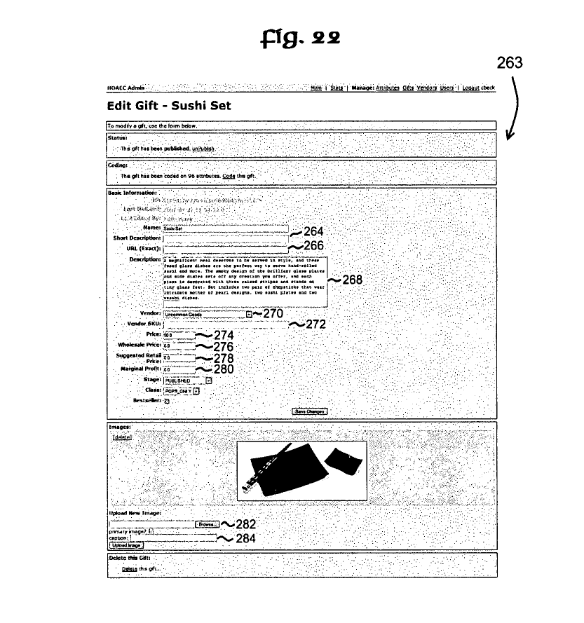

FIG. 22 is a GU “Gift Coding Module” display screen 263 obtained by a selection of a link at GU Page 256 as shown at FIG. 21. FIG. 22 includes interactive data input points 264 through 284 as indicated.

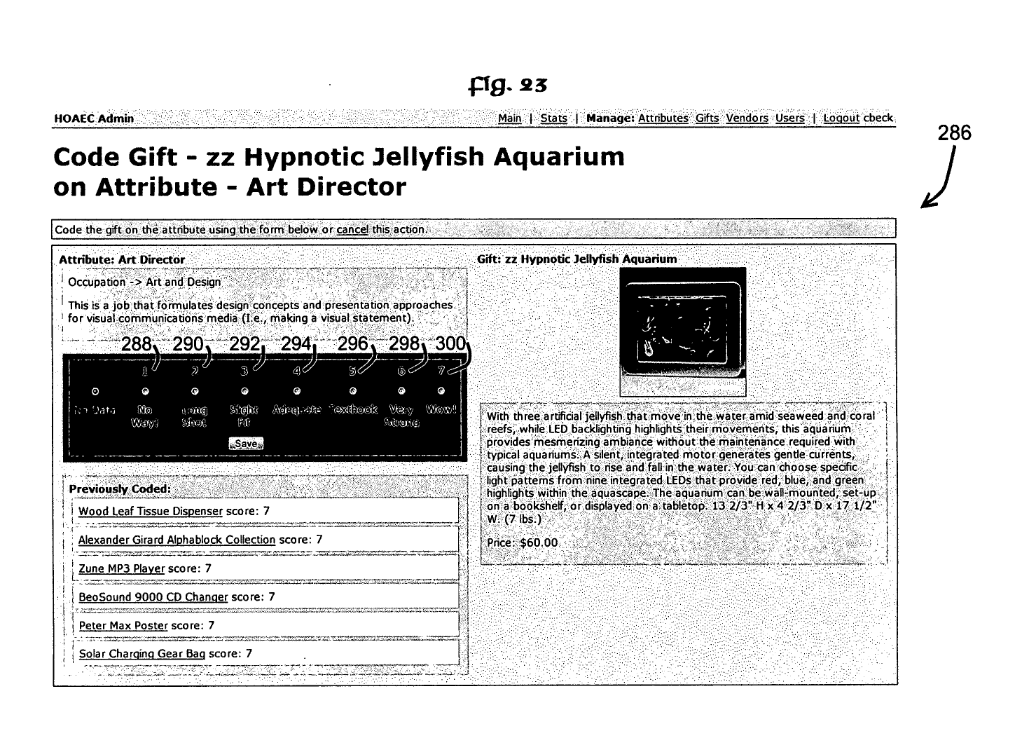

FIG. 23 is a GU “Gift Coding” display screen 286 obtained by selection of a link at GU Page 256 as shown at FIG. 21. FIG. 23 includes interactive data input points 288 through 300 as indicated.

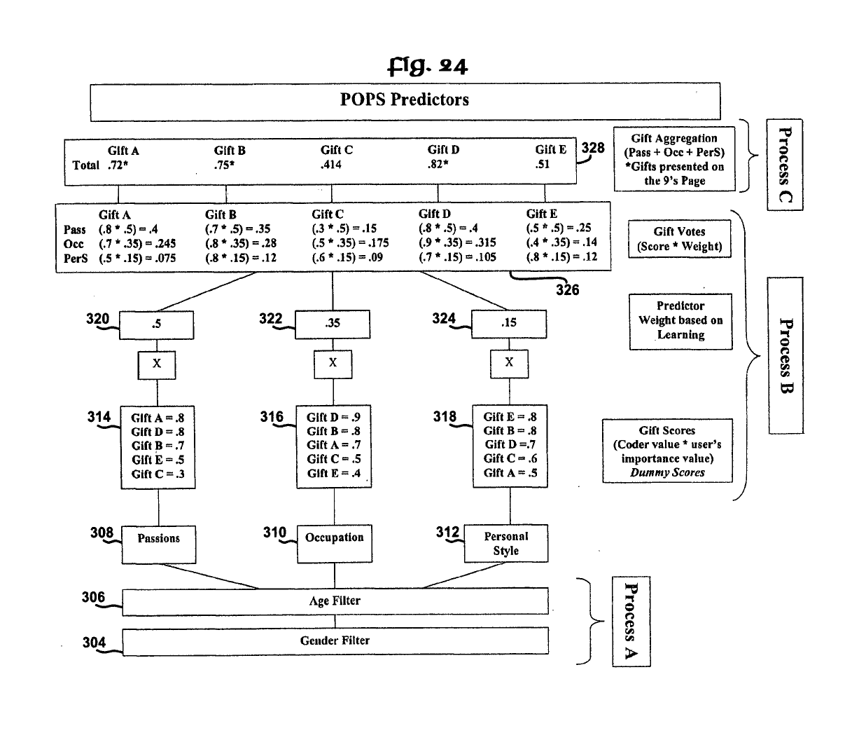

FIG. 24 illustrates the calculation of POPS predictor values, discussed in detail below.

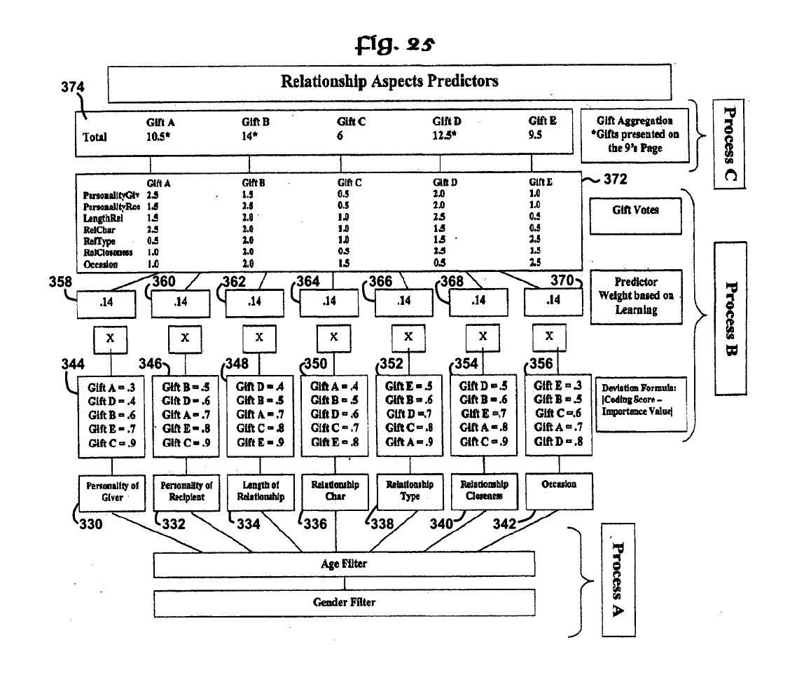

FIG. 25 illustrates the calculation of Relationship Aspect predictor values, discussed in detail below.

Three examples will now be given for using system 30 in accordance with the invention:
1) user 46 utilizes system 30 to obtain online a set of nine gift products as recommended gifts for a recipient having certain social relational aspects with respect to the user/giver;
2) user adds a proposed gift product to the total population of uncoded gift products; and
3) user participates to determine whether a proposed uncoded gift should be coded.

In the first example, user 46 utilizes system 30 via the internet and comes to FIG. 3. User 46 selects the “Get Started” link 94 and is taken to FIG. 4. The user then fills in the interactive fields beginning with field 110 of FIG. 4, that is giving the name of the gift recipient. User is then taken to FIGS. 5, 6 and 7 sequentially and interactively provides occasion information relevant to the gift giving selection including the “Passions” and “Occupations” and “Style” of the gift recipient. The TGP software 84 (as shown in FIG. 2) then calculates three recommended gifts each out of the “Best Sellers”, “POPS” and “Relationship” aspects. The top three in each of these three categories are then graphically displayed as the “Nines Page” in FIG. 8. The user is then free to select one or more gifts for the shopping cart to be purchased as gifts. In addition, user has the option of deselecting certain gift recommendations from the “Nines Page” and receiving alternative gift selections and the de-selection process can be repeated as often as desired.

In more detail, user 46 is sent from FIG. 4 to FIG. 5. At FIG. 5 user 46 is presented with a menu of “Passions and Interests” (totaling 312 individual selections, for example “Arts and Crafts” and “Attire.” User 46 is allowed to choose up to seven “Passions and Interests,” for example he can choose seven Arts and Crafts or he can choose one Arts and Crafts and from other “Passion and Interests” subcategories such as Attire or Collectors. In this example, user 46 has selected Arts and Crafts as the first Passions and Interest Category, as indicated at reference numeral 124. Arts and Crafts has twenty-two Passion subcategories, such as Basket Weaving and Bead Craft, from which to be selected by the selection arrow at Arts and Crafts category 124.

Upon selection of the Passions and Interests subcategory listed, namely Arts and Crafts, a menu of associated Passions as listed at reference numeral 126 is then displayed. Any one of those selected then count as one of the up to seven Passions and Interests to be selected. User 46 is prompted to rate each Passion and Interest.

After picking up to seven Passions and Interests the user is then taken to FIG. 6 where he will choose up to three Occupation categories from a total selection of nineteen, each selected category to be rated from one to seven. There are a total of 122 Occupation subcategories.

Referring to FIG. 7, user 46 is asked to name to up three personal style subcategories, out of thirteen personal style categories, each selected subcategory to be rated from one to seven.

Also at FIG. 7, user 46 is asked to choose up to three personality traits of the recipient at reference numeral 144 and is then asked to choose up to three personality traits of the giver of the gift at reference numeral 146. User 46 is then asked to describe the relationship from a menu listed at reference numeral 148 and also at reference numeral 150.

Turning now to FIG. 24, the calculation method for the personal style, occupation and passions and interests (POPS) will now be described. The calculation begins when all gifts stored in the memory are filtered for gender at 304 and age 306 as shown at FIG. 24. In other words, certain gift products available from the total population are excluded from further calculation in the POPS calculation of FIG. 24. Note that all gift products are coded as either one gender or for both genders so that for a female gift recipient, all male-only gifts would be excluded from the reduced pool of potential gifts.

For purposes of example, say that the value selected by the user 46 was a five for the Art and Design sub-subcategory Interior Design. In other words, in this example user 46 has assigned an importance of five to the occupation of Interior Design (seven being most important, one being least important).

Each product in the gift product population has a pre-coded (by a human coder) attribute value, between one and seven, for Interior Design. For example, a decorative vase is one of the population of gift products, with an attribute value of six with respect to Interior Design, while another one of the population of gifts is a video game and has an attribute value of one, with respect to Interior design.

As discussed above, user 46 continues to choose up to a maximum of seven Passions and Interests.

Then the following formula is applied at Passions box 308 for the entire population of product gifts (except those filtered by Gender 304 and Age 306):

[(GS_{Pass1}*IF_{Pass1})/49+(GS_{Pass2}*IF_{Pass2})/49+ . . . (GS_{Pass7}*IF_{Pass7})/49]/N

GS=coding score

Pass=attribute selected by user

IF=importance value established by user

N=the total number of attributes selected by the user

Note that GS_{Pass1} would be the attribute value (aka “coding score”) of six for the decorative vase and IF_{Pass1} would be an importance value of five for Interior Design in the example given above.

Now an analogous calculation is made at Occupation box based on inputs at FIG. 6, in particular at reference numeral 132 for each of up to three Occupation categories. The formula used for all product gifts (except those filtered by Gender 304 and Age 306):

[(GS_{Occ1}*IF_{Occ})/49+(GS_{Occ2}*IF_{Occ2})/49+ . . . (GS_{Occ7}*IF_{Occ7})/49]/N

Where

GS=coding score

Occ=occupation attribute selected by user

IF=importance value established by user

N=the total number of attributes selected by the user

In a strictly analogous fashion, a calculation is made for each gift product at Personal Style Box 312 at FIG. 24.

The score calculated at each of boxes 308, 310 and 312 are then normalized and ranked at respective boxes 314, 316 and 318. Each of those values is then multiplied by a predictor or coefficient at respective boxes 320, 322 and 324, and then all resultants are stored for each gift product at Gift Votes box 326.

Finally, the Passions, Occupations and Personal Style resultants for each gift product are summed for each gift product and stored at Gift Aggregation box 328. Then each gift product is ranked numerically and the top three gift products are sent to the Nine's Page and displayed as the top row of gifts as indicated in FIG. 8 at reference numeral 156.

As the top row of Passions, Occupations and Personal Style is calculated for display at top row 156 of FIG. 8, the bottom row 158 at FIG. 8 is also being calculated for Relationship Aspects (“RA”). The RA elements are Personality of Giver, Personality of Recipient, Length of Relationship, Relationship Characterization, Relationship Type, Relationship Closeness and Occasion, as shown at FIG. 25, respectively at reference numerals 330 through 340. Up to three importance values (or “trait” values) are inputted into Personality of Giver box 330 from interactive data input point 146. Up to three trait values are inputted into Personality of Recipient box 332 from interactive data input point 144 (at FIG. 7). One trait value is inputted into Length of Relationship box 334 from interactive data input point 120 (at FIG. 5). One trait value is inputted into Relationship Characterization box 336 from interactive data input point 150 (at FIG. 7). One trait value is inputted into Relationship Type box 338 from interactive data input point 118 (at FIG. 5). One trait value is inputted into Relationship Closeness box 340 from interactive data input point 148 (at FIG. 7). One trait value is inputted into Occasion box 342 from interactive data input point 122 (at FIG. 5). It should be noted that these traits are not numerical, but rather characteristics.

A digression from calculation at FIG. 25 is now necessary to discuss permanent data in storage, obtained for the purpose of facilitating FIG. 25 calculation. That is to say, predetermined data associated with each inputted trait for each gift is in permanent data storage for access for calculations associated with respective boxes 344-356. The predetermined data are based on standard deviation values DV for associated Product Attributes for each gift product for a given trait. There are fourteen Product Attributes (for example, two are “New” and “Exciting”). The DV values have two primary data inputs: 1) coding values assigned by averaging the numerical value (one to seven) assigned by each of three human coders for each Product Attribute for each gift; and 2) target values determined by a Target Survey of a pool of human responders to questioning about each possible trait with respect to each Product Attribute.

By way of example, a specific gift, say a tennis racquet, was previously coded by three human coders as an average value of six on “Exciting.” This is the coding value.

Further by way of example, in the Target Survey, a pool of human responders was asked how “exciting” a gift each responder wanted for a New relationship, rated from one to seven. The mean of all answers was 4.5. That is the “target value.” Therefore the deviation value for the tennis racquet for a new relationship is 1.5 (absolute value of 6-4.5). In this fashion standard deviation values, DV, are predetermined according to the following formula:

DV=|(PA₁G_{Y}−PA₁IVₘ)|+|(PA₂G_{y}−PA₂IVₘ)|+ . . . |(PA₁₄G_{y}PA₁₄IVₘ)/49

For all fourteen Product Attributes, where

PAₓG_{y} is the predetermined coded score on Product Attribute x for gift y; and

PAₓIVₘ is the target value on Product Attribute x for trait m.

In the preceding example, the first term (indicated between the first set of absolute value symbols would be 1.5 (6-4.5), where PA₁ was “New,” G_{y} was “Tennis Racquet,” IVₘ was “Exciting.” Hence, a standard deviation value has been predetermined and stored for each trait (such as “Exciting” for each Product Attribute for all gift products.

Now the calculations associated with respective boxes 344-356 will be described.

At Personality of Giver box 344, an RV value is calculated as follows:

Personality of Giver

RV=(DV_{Pers1}+DV_{Pers2}+DV_{Pers3})/N

DV=deviation value for the selected attribute for gift y

Pers=personality trait selected by the user

N=the total number of attributes selected by the user

At Personality of Recipient box 346, an RV value is calculated as follows:

Personality of Recipient

RV=(DV_{Per1}+DV_{Per2}+DV_{Per3})/N

DV=deviation value for the selected attribute for gift y

Pers=personality trait selected by the user

N=the total number of attributes selected by the user

At Length of Relationship box 348, an RV value is calculated as follows:

Length of Relationship

RV=DVLR

DV=deviation value for the selected attribute for gift y

LR=trait selected by the user

At Relationship Characterization box 350, an RV value is calculated as follows:

Relationship Characterization

RV=(DV_{RC1}+DV_{RC2}=DV_{RC3})/N

DV=deviation value for the selected attribute for gift y

RC trait selected by the user

N=the total number of attributes selected by the user

At Relationship Type box 352, an RV value is calculated as follows:

Relationship Type

RV=DVRT

DV=deviation value for the selected attribute for gift y

RT=trait selected by the user

At Relationship Closeness box 354, an RV value is calculated as follows:

Relationship Closeness

RV=DV_{RC1}

DV=deviation value for the selected attribute for gift y

RC1=trait selected by the user

At Occasion box 356, an RV value is calculated as follows:

### Occasion

RV=DV_{Occ}

DV=deviation value for the selected attribute for gift y

Occ=trait selected by the user

The RV value for each gift in each of boxes 344-356 is ranked from lowest to highest, since the calculation is based on standard deviation. Then each gift product is given a normalized rank value (the lower the RV deviation value, the higher the rank value). Then the normalized rank value for each gift product is multiplied by corresponding RA predictor coefficients respectively illustrated at boxes 358 through 370. The resulting Relationship Aspect (RA) values for each gift product are then collated by gift product as shown at Voting box 372.

Then the RA values for each gift product are summed as shown in Aggregator box 374. Then the gift product scores are compared and the top three gift products are selected from Aggregator box 374 for display on middle row 158 of the “Nine's Page,” as shown at FIG. 8. In this example, Gifts A, B and D had the highest gift product scores and would thus be the three gift recommendations displayed on the “Nine's Page.” It should be remembered that in practice the total number of gift products with associated gift product scores will typically be much higher than the five gifts illustrated in FIG. 25, usually numbering in the hundreds.

Gift products are also ranked numerically for Best Seller values and sent to the Nine's Page and displayed as the bottom row of gifts as indicated in FIG. 8 at reference numeral 160. Those skilled in the art will recognize that there are many different suitable approaches for calculating and ranking best sellers. There is currently no preferred method for selecting best sellers but one method under consideration is, in addition to initial filtering of gender and age and factoring in POPS and Relationship aspects, sales and other marketing considerations would also be factored in. This concludes the first example. Also, it should be noted that if any gift recommendation from rows 156-160 should be discarded, the next ranked gift from that row, whether POPS, Best Seller or RA, will be substituted, thereby restoring the total number of gift recommendations to nine. It should also be noted that the selection system can be a learning system by, for example, incrementing coefficients (such as shown at FIG. 24 and FIG. 25) when the associated calculative path has been successful for a particular gift, i.e. user 46 selects that particular gift. Likewise, system 30 can also learn by decrementing unsuccessful calculative path for a particular gift, e.g. when that particular gift has been discarded from the Nine's Page by user 46.

The second example of using system 30 will now be discussed. Referring to FIG. 21, user 46 will access system 30 (see FIG. 1) via the Internet as a previously registered user so as to be taken directly to FIG. 11 for log-in (TGP). User 46 then selects reference numeral 184 for the link “Your Gift Ideas” and proposes a gift along with text, graphics or other descriptive subject matter as desired. Then the proposed gift product may be voted on at the “Thumbs Up-Thumbs Down” GGSS page 252 then a group of users will then be invited to vote on the suitability of the gift and if 75% or more of the votes are positive the gift will be approved for coding at the GU stage 256 (i.e. “Gift University”). In addition, gifts may be proposed for “Thumbs Up-Thumbs Down” by recommendation at the “Gift Dilemmas” forum at FIG. 20.

In the third example, a set of trained and selected coders are used to code a proposed gift in GU to be added to The Gift Professor. In this process, the coders are rewarded or compensated for coding a gift and gift product in the GU stage 258 at FIG. 21. After the proposed gift product has been coded by five coders, the proposed gift product will be reviewed by a human or automated moderator at stage 260 of FIG. 21 for final approval as a published Gift Product in the TGP stage and therefore selectable as a gift for purchase.

Each interactive step of GGSS will have a point value assigned for contributor's who wish to participate. The interaction between GU and the moderator will entail a training system. Those who are selected as coders, through a series of tests, will also be rewarded, but to a greater extent. Points accumulated can be redeemed for cash or gifts to be chosen by the recipient.

It should be apparent that the invention not only accomplishes the major functions required from such articles but does so in a particularly advantageous manner. It should be equally apparent, however, that various minor and equivalent modifications from the embodiments disclosed herein for illustrative purposes could be employed without departing from the essence of the invention. It is to be understood, therefore, that the invention should be regarded as encompassing not only the subject matter literally defined by the claims which follow, but also technical equivalents thereof.

What is claimed is:

1. A method of operating a system for recommending one or more gifts to a user, for a gift recipient, the method comprising:
a) determining social relational aspects between a giver and the gift recipient;
b) determining personality traits of the giver or the recipient; and
c) electronically identifying, based on the determinations of steps a) and b), and then displaying to the user one or more recommended gifts for purchase.

2. The method of claim 1 wherein identifying recommended gifts includes predetermining coded values for a list of product attributes for potential recommended gifts.

3. The method of claim 2 wherein calculating recommended gifts includes comparing the predetermined coded values for a list of product attributes with importance values for traits selected by the user, in order to establish a standard deviation value between the predetermined coded values and the importance values for traits selected by the user, for potential recommended gifts.

4. The method of claim 1 wherein one of the social relational aspects included is gender.

5. The method of claim 1 wherein one of the social relational aspects included is age difference.

6. The method of claim 1 wherein one of the social relational aspects included is length of relationship.

7. The method of claim 1 wherein one of the social relational aspects included is categorizing a relationship between the giver and the recipient.

8. The method of claim 1 wherein one of the social relational aspects included is nature of occasion.

9. The method of claim 1 wherein one of the social relational aspects included is relationship characterization.

10. The method of claim 1 wherein one of the social relational aspects included is relationship closeness.

11. The method of claim 1 wherein one of the social relational aspects included is the gift receiver's personality.

12. The method of claim 1 wherein one of the social relational aspects included is the gift giver's personality.

13. A method of building a database of products for a system, the system providing a set of gift recommendations to a user, the method comprising:
(a) providing means for a system community member to propose at least one gift product;
(b) providing numerical criteria for establishing when a gift product has reached a mathematical threshold of approval;
(c) coding each gift product for certain gift recommendation criteria;
(d) applying a moderation process for evaluating the coding of step c; and
(e) entering a sufficiently evaluated coded gift product into a population of coded gift products.

14. The method of claim 13 further including the step of rating each gift for predetermined product attributes.

15. The method of claim 13 wherein the numerical criteria are met by a predetermined ratio of favorable to unfavorable votes on the proposed gift by other system community members.

16. A method of causing a system to learn and thereby become a better predictor, the method comprising:
a) providing a system prediction algorithm for a particular gift product;
b) comparing the predictor to a user's action;
c) incrementing or decremented coefficient of probability, if appropriate, for the associated variable; and
d) thereafter using the incremented or decremented coefficient of probability, until further modified.

17. The method of claim 16 wherein the user's action of step b) is the selection and purchase of a recommended gift and wherein in step c) the associated variable of the selected gift is incremented by a predetermined amount.

18. The method of claim 16 wherein the user's action of step b) is the rejection of a recommended gift and wherein in step c) the associated variable of the selected gift is decremented by a predetermined amount.

19. A method of expanding an at least partially uncoded population of gift products with one or more coded gift products, the method comprising:
a) providing means for coding an uncoded gift product, utilizing parameters assignable as numerical values indicating social relational attributes of the gift product;
b) motivating a competent gift product coder to code a specified uncoded gift product, utilizing the parameters by assigning as numerical values indicating social relational attributes of the gift product; and
c) adding the coded gift product to a population of coded gift products.

20. The method of claim 19 wherein the lowest coding value is one and the highest coding value is seven.

21. A computer readable medium containing instructions for executing a method of using information about an intended gift recipient to identify an appropriate gift from among a plurality of possible gifts, the method comprising the steps of:
populating a computer-readable database with the plurality of possible gifts, wherein each of the possible gifts is evaluated and assigned one or more numeric gift values which are stored in the computer-readable database in association with the possible gift;
receiving the information about the intended gift recipient, wherein the information includes a passion, an occupation, and a style of the intended gift recipient and a nature of a relationship between a gift giver and the intended gift recipient, and assigning the information one or more numeric information values;
electronically searching the computer-readable database to identify plurality of appropriate gifts from the plurality of possible gifts based upon the numeric gift values and the numeric information values;
ranking the appropriateness of each appropriate gift of the plurality of appropriate gifts based upon the numeric gift values and the numeric information values, and
displaying one or more of the appropriate gifts in order of their appropriateness rankings.
